(19) United States
(12) Patent Application Publication
(10) Pub. No.: US 2021/0320801 A1
(43) Pub. Date: Oct. 14, 2021

(54) SYSTEMS AND METHODS FOR MULTI-FACTOR VERIFICATION OF USERS USING BIOMETRICS AND CRYPTOGRAPHIC SEQUENCES

(71) Applicant: Genesys Telecommunications Laboratories, Inc., Daly City, CA (US)

(72) Inventor: Felix Wyss, Indianapolis, IN (US)

(73) Assignee: Genesys Telecommunications Laboratories, Inc., Daly City, CA (US)

(21) Appl. No.: 16/843,619

(22) Filed: Apr. 8, 2020

(51) Int. Cl. H04L 9/32; G10L 17/06; G06K 9/00

(52) U.S. Cl. CPC H04L 9/3231; G06K 9/00281; G06K 9/00288; G10L 17/06

(57) ABSTRACT

A method for verifying an individual's identity for granting access to a computer system that includes receiving a personal identifier of the individual and data related to the individual speaking an authentication sequence. The method includes performing a biometrics identity proof that includes: identifying a first set of characteristics from the data; retrieving, from a database, a second set characteristics linked to the personal identifier of the individual; and comparing the first set of characteristics against the second set of characteristics to determine a similarity score. The method includes performing a proof of possession of an authentication device that includes determining whether a recognized value of the authentication sequence matches an expected value of the authentication sequence. The method includes calculating a confidence score for verifying the individual's identity based the similarity score and whether a match was determined.

### BACKGROUND OF THE INVENTION

The present invention generally relates to information security systems and methods, as well as biometrics, such at voice and facial recognition. More particularly, but not by way of limitation, the present invention pertains to authenticating users via a multi-factor verification process combining biometrics and cryptographically generated authentication sequences.

### BRIEF DESCRIPTION OF THE INVENTION

The present application describes a method for verifying an identity of an individual for granting the individual access to a computer system. The method may include the steps of receiving, in one or more communications via one or more communication channels, a personal identifier of the individual and data related to the individual speaking an authentication sequence. The method may include performing an identity proof that includes biometrics. The biometrics identity proof may include the steps of: identifying a first set of characteristics from the data; retrieving, from a database, a second set characteristics linked to the personal identifier of the individual; and comparing the first set of characteristics against the second set of characteristics to determine a degree of similarity or similarity score therebetween. The method may also include performing a proof of possession of an authentication device that includes the steps of: determining a recognized value of the authentication sequence spoken by the individual based on the data; determining an expected value of the authentication sequence; and determining whether the recognized value of the authentication sequence matches the expected value of the authentication sequence. The method may include calculating a confidence score for verifying the identity of the individual based on both: the similarity score; and whether the recognized value of the authentication sequence is found to match the expected value of the authentication sequence.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a diagram illustrating a system protected with multi-factor authentication including a password and cryptographic authentication sequence;

FIG. 2 is a flowchart illustrating a process for multi-factor authentication including a cryptographic authentication sequence and voice biometrics verification;

FIG. 3 is a diagram illustrating an embodiment of a system protected with multi-factor authentication including a cryptographic authentication sequence and voice biometrics verification;

FIG. 4 is a diagram illustrating an alternative embodiment of a system protected with multi-factor authentication including a cryptographic authentication sequence and voice biometrics verification;

FIG. 5 is a diagram illustrating an embodiment of a system protected by multi-factor authentication including a cryptographic authentication sequence with both facial and voice biometrics verification; and

FIG. 6 is a flowchart illustrating an exemplary method for verification related to the system of FIG. 5.

### DETAILED DESCRIPTION OF THE INVENTION

To promote an understanding of the invention of the present application (or “present invention”), reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials, components, or methods have not been described in detail in order to avoid obscuring the present invention. Additionally, further modification in the provided examples or application of the principles of the invention, as presented herein, are contemplated as would normally occur to those skilled in the art.

Additionally, as used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure or characteristic described in connection with the given example may be included in at least one embodiment of the present invention. Thus, appearances of the phrases “an embodiment”, “one embodiment”, “present embodiments”, “exemplary embodiments”, “certain embodiments” and the like are not necessarily all referring to the same embodiment or example. Further, particular features, structures or characteristics may be combined in any suitable combinations and/or sub-combinations in one or more embodiments or examples.

Embodiments of the present invention may be implemented as an apparatus, method, or computer program product. Accordingly, example embodiments may take the form of an entirely hardware embodiment, an entirely software embodiment (including firmware, resident software, micro-code, etc.), or an embodiment combining software and hardware aspects that may all generally be referred to herein as a “module” or “system.” Further, example embodiments may take the form of a computer program product embodied in any tangible medium of expression having computer-usable program code embodied in the medium. In addition, it will be appreciated that the figures provided herewith are for explanation purposes to persons ordinarily skilled in the art and that the drawings are not necessarily drawn to scale. It will be further appreciated that the flowchart and block diagrams provided in the figures illustrate architecture, functionality, and operation of possible implementations of systems, methods, and computer program products according to example embodiments of the present invention. In this regard, each block in the flowchart or block diagrams may represent a module, segment, or portion of code, which includes one or more executable instructions for implementing the specified logical functions. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the fimction/act specified in the flowchart and/or block diagram block or blocks.

As will be appreciated, a most common form of authentication to control access to a computer system or software application employs a personal identifier in combination with a secret password. The personal identifier may be derived from an individual's or user's name or e-mail address. The personal identifier is not considered secret, so the security of the system relies on the password remaining a secret. Users (also referred to herein as individuals) are prone to using the same password at multiple services. Further, users often do not choose sufficiently long passwords with high entropy, which makes the passwords vulnerable through brute-force and dictionary attacks.

Additional factors may be added to increase security to a system or application, such as challenge questions or cryptographic authentication devices in the user's possession. Examples of cryptographic authentication devices may include security tokens, such as RSA SecurID or Google Authenticator. The cryptographic authentication devices, which include both hardware tokens (e.g., key fobs) or software tokens, generate a new six-digit number that changes at regular time intervals. As an example, the generated digit sequences are derived cryptographically from the current time and a secret key unique to each token and known to the authenticating system. By providing the correct value at login, the user claiming their identity proves with high likelihood that they are in possession of the cryptographic authentication device that generated the current digit sequence.

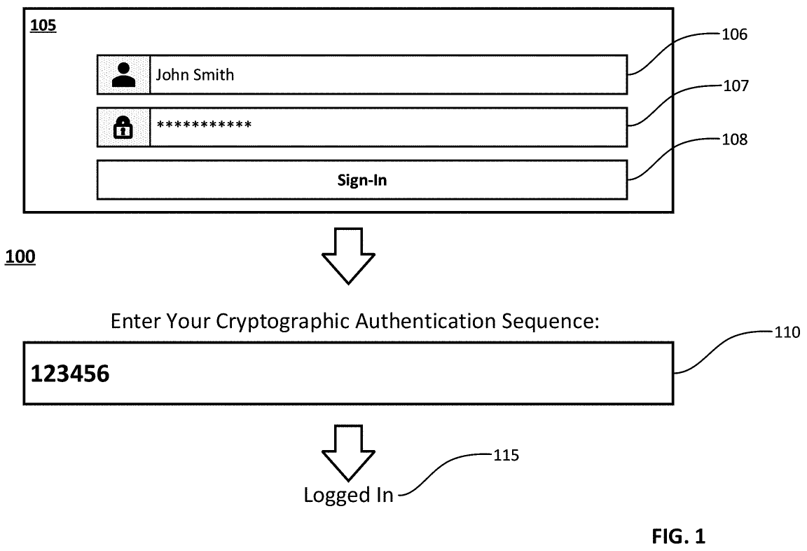

With specific reference to FIG. 1, a diagram is provided showing a system protected with multi-factor authentication that includes a password and cryptographic authentication sequence, indicated generally at 100. At sign-in, a user may be presented with a window 105 in a user interface comprising a space for entering a user identification (or “user ID”) 106, a space for entering a password 107, and a sign-in button 108. The user enters their user ID into the space at 106, which in this example is “John Smith”. User John Smith then enters a password into the space 107, which may be hidden from view. The user then clicks “Sign-In” at 108. The system then takes the user to a screen prompt to enter a cryptographically generated authentication sequence, which may be referred to herein as a “cryptographic authentication sequence” or, simply, “authentication sequence”) 110. The user accesses the authentication sequence from a device, such as a key fob or a smartphone, or an application on another device and enters the authentication sequence. The system verifies the code and the user is then logged in 115.

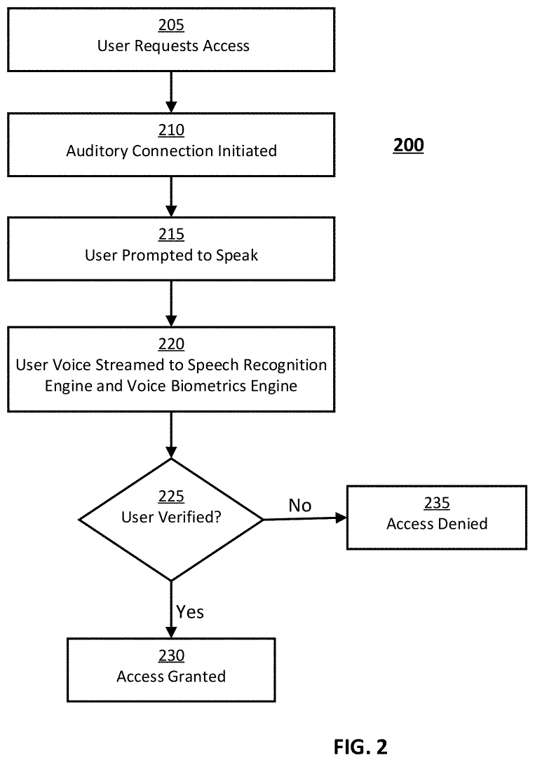

With specific reference now to FIG. 2, a flowchart is provided illustrating a method 200 for multi-factor authentication including a cryptographic authentication sequence and voice biometrics verification. According to exemplary embodiments, the present invention proposes a such methods for enhancing multi-factor authentication. Instead of using a password as a factor for authentication, the voice of the user may be verified using voice biometrics as a factor for authentication.

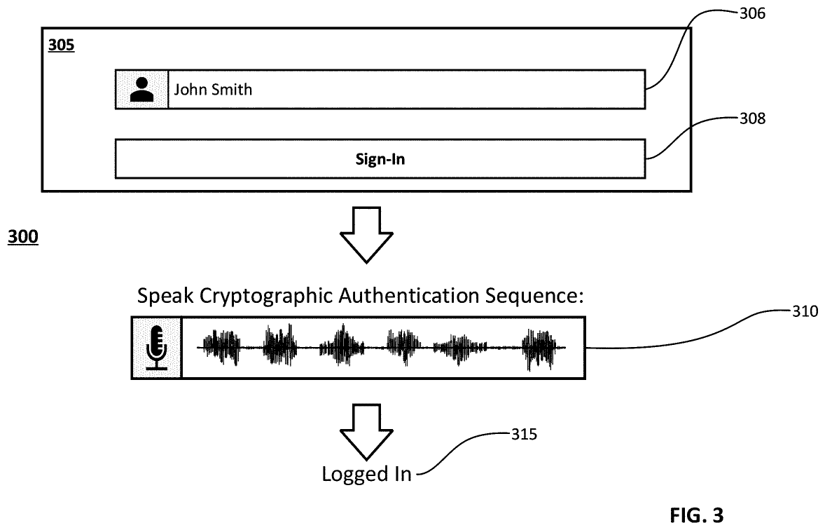

The method 200 begins at operation 205 where a user requests access, i.e., attempts to sign-in or log-in to the system. For example, the user may be requesting access to a computer system or to a software application through a user interface on a user device (also referred to herein as a “computing device”), such as a smart phone, tablet, laptop, or other mobile device. At sign-in, a user may be presented with a window comprising at least a space where the user may enter their user ID, as exemplified in FIG. 3 and described in greater detail below. When the user requests access, which may be through a sign-in request, the system triggers voice identification. According to exemplary embodiments, a user may also enter a password in conjunction with their user ID as an additional factor for authentication. Control is then passed to operation 210, and the process 200 continues.

In operation 210, an auditory connection is initiated. For example, the system initiates an auditory connection with the user. According to exemplary embodiments, the connection may be made by leveraging a built-in microphone supported by the device being used by the user. In another embodiment, the connection may be made by the system initiating a telephone call to the user using a previously registered phone number associated with the user account. The connection needs to be capable of supporting voice from the user to verify the user. Control is then passed to operation 215, and the process 200 continues.

In operation 215, the user is prompted to speak. For example, the system may prompt the user to speak the current value of a cryptographic authentication device. The prompt may be audible or visual. For example, the user may see an indication on the display of their device indicating him to speak. The system may also provide an audio prompt to the user. Control is passed to operation 220 and the process 200 continues.

In operation 220, the user's voice is streamed. For example, the system captures the voice of the user as they speak the current value of the cryptographic authentication device. The token may be a cryptographic token value. The captured voice of the user is concurrently fed into an automatic speech recognition engine (or “speech recognition engine”) and a voice biometrics verification engine. In another embodiment, the user's utterance may be captured in the browser/client device and submitted to the server in a request. Control is passed to operation 225 and the process 200 continues.

In operation 225, it is determined whether the user is verified. If it is determined that the user is verified, control is passed to operation 230 and the user is granted access. If it is determined that the user is not verified, control is passed to operation 235 and the user is denied access.

The determination in operation 225 may be based on any suitable criteria, as would be appreciated by one of ordinary skill in the art. For example, the speech recognition engine recognizes the user verbalized input value of the cryptographic authentication device to verify that the user is in possession of the device. By asking the user to speak the current value of the authentication sequence, the speech recognition engine can capture the digit values for verifying against known or expected values. The voice biometrics verification engine verifies that the speaker is the person claiming to be the user requesting access. The voice biometrics verification engine is capable of verifying whether the spoken utterance belongs to the user and confirm identity. Verification by the speech recognition engine and the voice biometrics verification engine may be triggered when the confidence level of an engine reaches a threshold. The user is thus able to prove that they are in possession of the cryptographic authentication device while the user's claimed identity is verified through their voiceprint.

With specific reference to FIG. 3, a diagram is provided illustrating an embodiment of a system protected with multi-factor authentication including a cryptographic authentication sequence and voice biometrics verification, indicated generally at 300. At sign-in, a user may be presented with a window 305 in a user interface comprising a space for entering a user ID 306. A sign-in button 308 may also be provided. The user enters their user ID into the space at 306, which in this example is again “John Smith”. The user may enter their user ID via any of the ways described herein. The user clicks “Sign-In” at 308. The system then takes the user to a screen prompt for speaking a current value of a cryptographic authentication device 310. The user accesses the digits of the authentication sequence from their device, such as key fob, smartphone, or application on another device, and speaks the digits to the system. The system verifies the user's identity through the process 200 described in FIG. 2, and the verified user is then logged in 315.

A “replay attack” may be prevented through using the embodiments described in process 200. A person using their voice when interacting with others can be easily recorded by bystanders, which makes text-dependent single-phrase voice authentication solutions problematic. For example, a user speaking a hard-coded passphrase, such as “I'm John Smith, my voice is my password”, is vulnerable to recording by a bystander who can play it back at a later time to system, impersonating the user. While some systems might try to counter this by keeping a history of utterances by the user and comparing them for similarity, recordings may be distorted so that the similarity threshold is not met, but the voiceprint still matches. Using a cryptographically generated random digit sequence for voice verification makes replay attacks much more difficult as an attacker must have a recording of the user speaking all ten digits at least once as well as be in possession of the user's cryptographic authentication device.

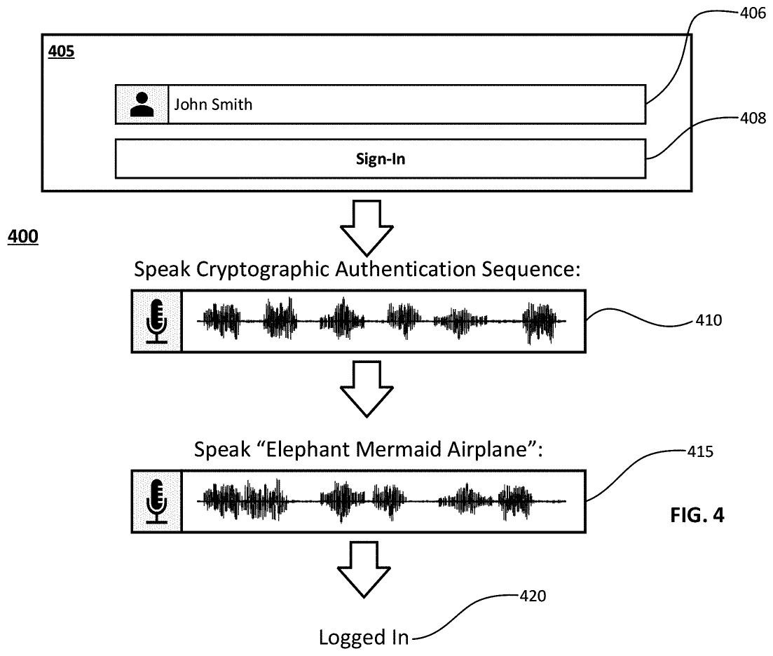

With specific reference to FIG. 4, a diagram is provided illustrating an alternative embodiment of a system protected with multi-factor authentication including a cryptographic authentication sequence and voice biometrics verification, indicated generally at 400. As will be seen, in this case, the system may further prompt the user to speak a few words randomly selected from a large collection of words.

At sign-in, a user may be presented with a window 405 in a user interface comprising a space for entering a user ID 406. A sign-in button 408 may also be provided. The user enters their user ID into the space at 406, which in this example is again “John Smith”, and the user then clicks “Sign-In” at 408. The system takes the user to a screen prompt for speaking a cryptographic authentication sequence 410. The user accesses the digits of the authentication sequence from a device, such as a smartphone or an application on another device and speaks the digits to the system.

As an additional step, the user may then be prompted to speak a few words randomly selected from a large collection of words 415. A user may be prompted to speak a few words randomly a plurality of times, for more security or if the reading wasn't accurate due to background noise the first time. Poor speech recognition confidence may also trigger a repeat of prompts for the user to speak and/or a poor voice biometrics confidence of a match. Furthermore, the prompt for a user speaking the authentication sequence does not have to occur prior to the prompt to speak words. The prompt for a user speaking the authentication sequence may occur after the prompt to speak words. The system verifies the user's identity through the process described in FIG. 2, and the verified user is then logged in 420.

Adding the step of prompting a user to speak randomly selected words makes it nearly impossible for an attacker to mount a replay attack as it would be infeasible to record the user speaking all possible words from the challenge collection. This step is helpful in a situation where an attacker within listening proximity to the user speaking the current authentication sequence during the authentication step creates a separate authentication session with the system claiming to be the user. As the user speaks the current value of the cryptographic authentication device, the attacker captures the genuine user's speech and immediately passes it on the attacker's session. If the system is suspicious by receiving identity claims from two sessions simultaneously or in the same cryptographic authentication device update interval, the attacker would have to be able to temporarily suppress or delay the network packets from the authenticating user. If the system uses an additional random word challenge as described above, the genuine user's and the attacker's authentication session would receive a different randomly chosen set of challenge words. Even if the impostor could capture the authentication sequence values in real-time, the challenge would fail. Challenge words may be selected for phonemic balance, distinctiveness, pronounceability, minimum length, and easy recognizability by the speech recognition system.

In other exemplary embodiments, the system could adaptively decide to perform the word challenge described above based on several criteria. For example, the criteria might include: the identity claim session originates from a different IP address than the last session, the identity claim session is from a new client of new browser instance (which may be tracked based on a cookie or similar persistent state stored in the client), no login has occurred for a specified interval of time, there are unusual login patterns (e.g., time of day, day of the week), there are unusually low confidence values in the voice match, there are several identity claim sessions for the same user in short succession, the system detects higher levels of background noise or background speech (which might indicate that the user is in an environment with other people present), and set for random intervals, to name several non-limiting examples.

In other exemplary embodiments, a user may speak their user ID instead of being required to enter the user ID in the form. The system may allow the user to speak their name as the identity claim. In other exemplary embodiments, if the browser used by the user to access the system or application does not support capturing audio through WebAudio or WebRTC, or the computer has no microphone, the system could call the user once the user signs in. The call may be placed on a previously registered phone number to establish the audio channel. Using a previously registered phone number would add additional security as an imposter would have to steal the phone or otherwise change the phone number associated with the user account.

In other exemplary embodiments, a cryptographic authentication device may be used which is specifically designed for voice biometrics application instead of the digit-based multi-factor authentication tokens currently in use. In this case, the cryptographic authentication device generates a set of words instead of digits as an authentication sequence. For input through a keyboard or keypad, numeric digit-based authentication sequences are generally more practical. However, in systems that include speech recognition, a set of words as the authentication sequence can provide higher levels of security and ease-of-use. For example, a six-digit authentication sequence offers 1,000,000 possible values. Selecting three words at random from a dictionary of 1000 words provides 1,000,000,000 possible combinations.

In other exemplary embodiments, added protection of user devices may be provided. For example, many users use authentication applications (soft tokens) residing on their mobile devices. Many mobile devices use a fingerprint sensor to unlock the device for use. Thus, the user's fingerprint may be intrinsically coupled to the embodiments described herein as the fingerprint is needed to access the authentication device along with the user's voiceprint to verify a user's identity. Furthermore, an implication is that the user is currently in physical possession of the device hosting the authentication device when speaking the authentication sequence.

In other exemplary embodiments, the authentication process may occur through a phone using an interactive voice response (IVR) system as opposed to a UI. The user may call into an IVR system using a device, such as a phone. The IVR system may recognize the number associated with the device the user is calling from and ask the user for a current value from the authentication device (e.g., security token). If the system does not recognize the number the user is calling from, the system may ask the user for a personal identifier before proceeding with the authentication process.

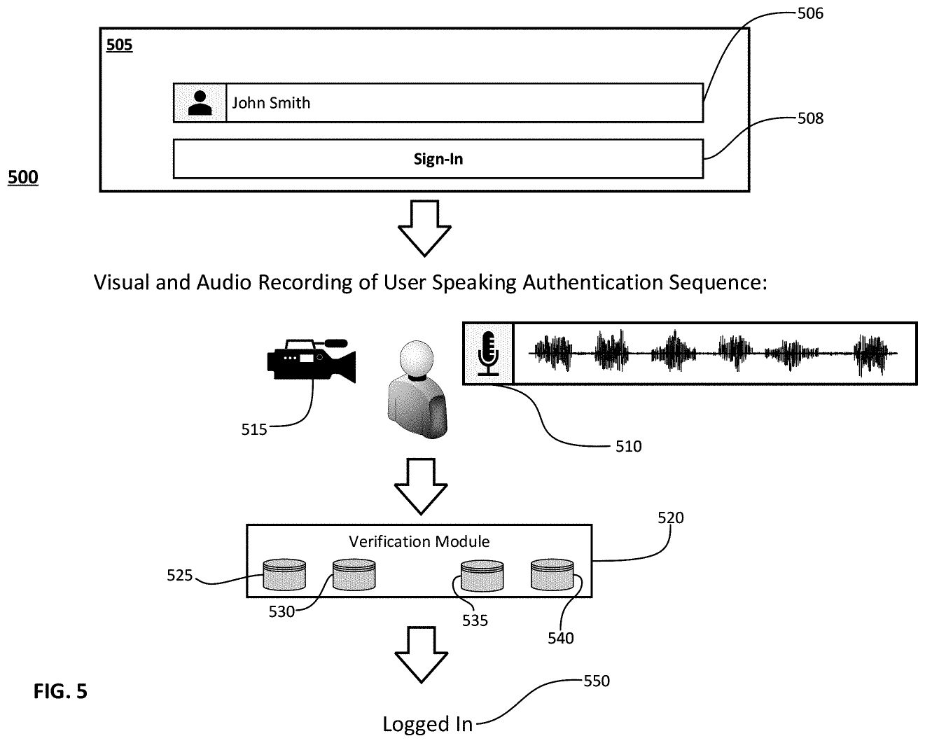

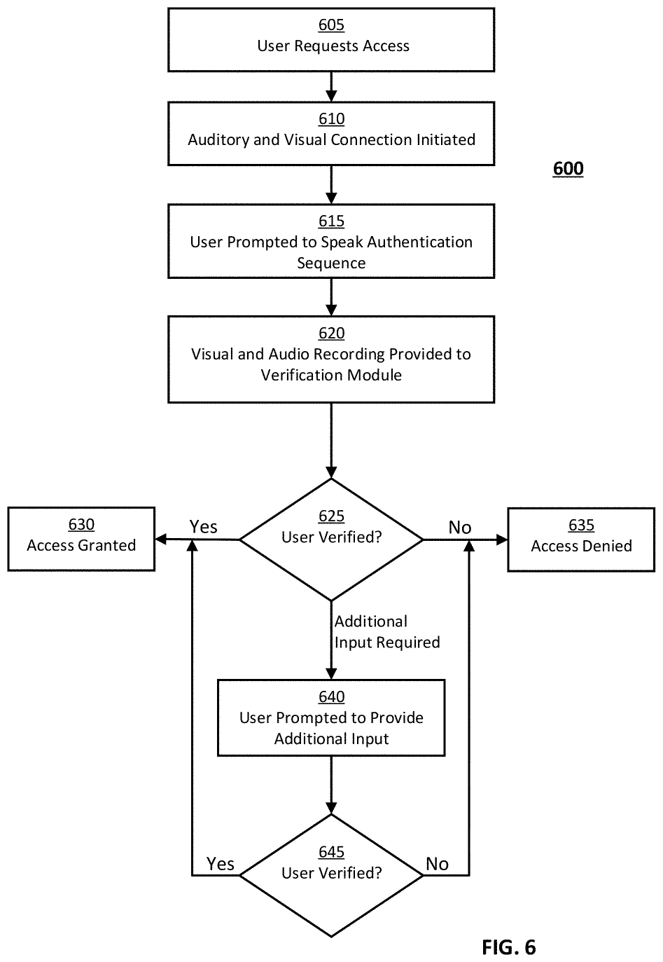

With reference now to FIGS. 5 and 6, alternative embodiments of the present invention are shown in which biometrics, including both voice and facial recognition, are combined with a cryptographically generated authentication sequence to verify the identity of an individual or user. As already discussed, authenticating users of a computer system using only passwords can become quite inconvenient, as increasingly longer and more complex passwords are required to maintain sufficient entropy to resist brute-force attacks. Such passwords also have to be changed periodically, which can further inconvenience users and lead to forgotten passwords. While biometrics authentication methods can alleviate some of these concerns, such methods generally require specialized sensors and/or pose a risk for spoofing or replay attacks when used in isolation. As will be seen, embodiments of the present invention offer systems and methods for user verification that both promote efficiency and user convenience while still delivering robust security.

By way of background, biometrics refers generally to physical or behavioral human characteristics to that can be used to digitally identify a person to grant access to systems, devices or data. Examples of biometrics identifiers include recognition of voice characteristics, as already introduced, as well as facial characteristics, each of which is considered unique to the individual. As used in describing the present embodiments, the use of voice characteristics to identify a person will be referred to as “voice recognition biometrics” or, simply, “voice biometrics”, while the use of facial characteristics to identify a person will be referred to as “facial recognition biometrics” or, simply, “facial biometrics”.

Voice biometrics, as discussed, refers to the analysis of a person's voice to verify their identity. In general, voice biometrics uses the acoustic features of speech that have been found to differ between individuals. These acoustic features can reflect both anatomy, facial movements, and learned behavioral patterns. Specifically, airways and soft-tissue cavities, as well as the shape and movement of the mouth and jaw, influence voice patterns to create a unique “voiceprint.” Using this voiceprint, a person can be identified by comparing voice characteristics to characteristics of a known voices saved within a database. As used therein, a voice biometrics verification engine, thus, refers to a module or system that can uniquely identify a person by analyzing characteristics of the person's voice.

Facial biometrics refers to the capability of identifying a person from visual characteristic of that person's face. There are multiple methods in which facial recognition systems work, but in general, these systems function by comparing selected facial features from a given image with features of known faces stored within a database. Facial biometrics also includes the identification of a person through facial movement, particularly movement of the lips and mouth as related to speech. For example, a person may be identified via the way the person moves their lips when producing specific sounds. Accordingly, as used herein, a facial biometrics verification engine refers to a module or system that can uniquely identify a person by analyzing visual facial characteristics, such as facial textures, shape, or other static characteristics. Additionally, as used herein, a facial biometrics verification engine also may include capabilities for identifying a person by analyzing unique facial movements, such as lip and mouth movements when speaking.

With specific reference to FIG. 5, a system 500 is schematically represented that fuses facial and voice biometrics with a cryptographic multi-factor authentication token or device (or simply “cryptographic authentication device”). As will be seen, the combination of these may be used to authenticate a user by satisfying with high confidence both a proof of identity and a proof of possession of cryptographic authentication device. As used herein, a proof of identity refers to a user proving their identity, while the proof of possession of cryptographic authentication device refers to the user proving they are in possession of a particular cryptographic authentication device. As will be seen, in accordance with exemplary embodiments, a user may satisfy both of these proof types by speaking a current value of an authentication sequence as visual data is taken of the user's face (also referred to as “face data”) and sound data is taken of the user's voice (also referred to as “voice data”) and provided as inputs to a verification module. Voice biometrics verification is then applied to the sound recording to provide a first proof of identity, while facial biometrics verification is applied to the visual recording of the user's face to provide a second proof of identity. The value of the authentication sequence as input by the user's voice and/or facial movements (i.e., lip reading) is then checked against an expected value (i.e., the expected value that is known by the authentication system) of the authentication sequence to provide the proof of possession of cryptographic authentication device. As will be appreciated, this final check also provides a “liveness verification” that would secure the system against replay attacks.

As shown in FIG. 5, the system 500 may include a window 505 that is presented to the user as part of a user interface. As an example, the window 505 may be displayed to the user via a screen associated with the user's computing device, such as a smartphone, tablet, or laptop. In accordance with the functionality described herein, the computing device includes a microphone, which may be used to record the user's voice, and a camera or video camera, which may be used to visually record the user's face. The window 505 may include a space for entering a user ID 506. Though not shown in the illustrated example, a space may also be provided for the user to enter a password in conjunction with their user ID, which may provide an additional factor for authentication. Alternatively, the user ID and password windows may be excluded altogether such that the system 500 instead relies on the other verifications proofs. As shown, the window 505 may further include a “Sign-In” button 508, which the user may activate to begin the authentication process. Alternatively, the sign-in button 508 may be omitted, and the authentication process may be initiated by another type of input, such as a voice command.

After the user has entered their user ID into the space at 506 and click the “Sign-In” button 508, the system 500 may take the user to a screen prompting the user to speak the current value of the authentication sequence. As will be appreciated, the current value is the sequence of digits that is presently being generated and displayed by the cryptographic authentication device in the user's possession. As discussed more above, the cryptographic authentication device may include a hardware device (such as key fobs) or a software application (such as RSA SecureID or Google Authenticator) that cryptographically generates a sequence of letters or numbers that change at regular intervals. Because such cryptographically generated authentication sequences cannot be guessed or determined by an attacker, knowledge of the current value proves possession of the cryptographic authentication device. It should be understood that the cryptographically generated authentication sequence may also include other type of characters, such as letters, words, or symbols, and that the use in the present example of “digits” is not intended to be limiting. Pursuant to the screen prompt, the user then speaks the current value of the authentication sequence. The user does this in a way so that the microphone 510 of the user's computing device records an audio recording of the user's voice and the video camera 515 of the user's computing device records a visual recording of the user's face.

The system 500, as further shown, may include a verification module 520. As indicated, in the illustrated example, voice data associated with the audio recording of the user's voice and/or face data associated with the visual or video recording of the user's face is provided as inputs to the verification module 520. The verification module 520 may include several component modules or engines for executing the desired verifications and proofs. For example, according to preferred embodiments, the verification module 520 may include a speech recognition engine 525. The verification module 520 may further include a voice biometrics verification engine 530, a facial biometrics verification engine 535, and a cryptographic sequence verification engine 540. The speech recognition engine 525 may also include bimodal speech recognition capabilities to improve recognition accuracy of the user's spoken inputs. The verification module 520 may verify a user's identity based on the face data and the voice data, as will now be discussed in more detail.

With reference now also to FIG. 6, a method 600 is provided by which a user's identity is verified using the previously introduced verification module 520. At initial operation 605, the verification process is initiated with a user requesting access to a network, computer system, data, etc. The method 600 may then continue with control being passed to operation 610.

At operation 610, auditory and visual connections are initiated. According to exemplary embodiments, an auditory connection is created to receive input from a built-in microphone supported by the computing device of the user. The auditory connection may be capable of supporting the real time transmission of voice data that is collected via the microphone over a network to the verification module 520, where the transmitted voice data is sufficient to verify the user via voice biometrics. The transmitted voice data, as discussed more below, may include raw auditory data collected by the microphone or preprocessed data (i.e., data that has been processed at the user device to identify certain characteristics). According to exemplary embodiments, the visual connection may be created to receive input from the built-in camera or video camera supported by the computing device of the user or from a data processing module on the device. Thus, the visual connection may be capable of supporting the real time transmission of visual data of the user's face (also referred to as “face data”) over a network to the verification module 520, where the transmitted face data is sufficient to verify the user via facial biometrics. The transmitted face data, as discussed more below, may include raw visual data taken of the user's face or preprocessed data (i.e., data that has been processed to identify certain facial characteristics and/or facial movements). The method 600 may then continue with control being passed to operation 615.

In operation 615, the user is prompted to speak the current value of the cryptographic authentication sequence being displayed on the user's cryptographic authentication device (e.g., security token or multi-factor authentication token). The prompt may be audible or visual. For example, the user may see a visual indication on the display communicating that they should speak the current value of the authentication sequence. The prompt may further indicate that the user should do this so that the microphone of the computing device is well positioned to record the user's voice and the video camera of the computing device records is trained on the user's face. The method 600 may then continue with control being passed to operation 620.

In operation 620, the face data and/or voice data of the user speaking the current value of the authentication sequence is provided as inputs to the verification module 520. The face data and voice data may be provided over the audio and visual connections previously initiated as part of operation 610. For example, the microphone 510 of the user's computing device may record the user's voice as they verbalize the authentication sequence, and the voice data derived therefrom (which may include raw data or processed data) may be fed or streamed over a network to the verification module 520. Within the verification module 520, the voice data may be directed as an input to the speech recognition engine 525 and the voice biometrics verification engine 530. At the same time, the camera 515 of the user's computing device may visually record aspects of the user's face as they verbalize the authentication sequence, and the visual face data derived therefrom (which may include raw data or processed data) may be fed or streamed over a network into the verification module 520. Within the verification module 520, the face data may be directed as an input to the facial biometrics verification engine 535.

In certain exemplary embodiments, the visual face data of the user verbalizing the authentication sequence may also be directed to the speech recognition engine 525. In such cases, the speech recognition engine 525 may be configured to include bimodal speech recognition. As will be appreciated, bimodal speech recognition refers to speech recognition that combines audio and visual information to enhance speech recognition, particularly, under poor audio conditions. In such embodiments, the system 500 may provide both the voice and face data of the user speaking the authentication sequence so that the both types of information can be used to improve recognition of the verbalized input. In other embodiments, only the visual recording of the user speaking the authentication sequence, i.e., the face data, may be used to recognize the verbalized input. The method 600 may then continue with control being passed to operation 625.

In operation 625, the user is verified. This verification is made pursuant to the received face and voice data that the user provided when speaking the current value of the authentication sequence. Unless otherwise limited herein, the verification provided in operation 625 may be based on any suitable criteria given the various components and verification engines of the verification module 520, as would be appreciated by one of ordinary skill in the art. In general, in accordance with the present invention, user verification may include the speech recognition engine 525 being used to recognize the verbalized sequence of digits provided by the user, which may be referred to as a “recognized value” of the authentication sequence. Once this is done, the recognized value is passed to the cryptographic sequence verification engine 540, where it is checked against an expected value (i.e., the expected value that is known by the authentication system) of the authentication sequence to prove the user is in possession of the cryptographic authentication device. Concurrently, the voice biometrics verification engine 530 uses the voice data to verify that the speaker is the person claiming to be the user requesting access, while the facial biometrics verification engine 535 verifies the same by using the face data. In each case, verification may be triggered when the confidence level of each engine reaches a predetermined threshold. Thus, at sign-in, the user proves that they possess the cryptographic authentication device, and the user's identity is verified through their unique voiceprint and facial characteristics.

The verification in operation 625 will now be described in more detail with reference to a first proof of identity, a second proof of identity, and a proof of possession of cryptographic authentication device.

In the first proof of identity, the verification module 520 proves identity based on facial biometrics. This verification may be implemented within the facial biometrics verification engine 535. For example, the facial characteristics of the user provided within the transmitted face data (for example, video recording) is compared against the facial characteristics of one or more visual recordings previously made of the user's face and saved to a database. Unless otherwise specifically limited, the facial biometrics verification engine 535 may perform this comparison and related analysis pursuant to any conventional facial biometrics technologies.

In the second proof of identity, the verification module 520 proves identity based on voice biometrics. This verification may be implemented within the voice biometrics verification engine 530. For example, the voice characteristics of the transmitted voice data (for example, audio recording) are compared against the voice characteristics of one or more recordings previously provided by the user and saved to a database. Unless otherwise specifically limited, the voice biometrics verification engine 530 may perform this comparison and related analysis pursuant to any conventional voice biometrics technologies.

In the proof of possession of cryptographic authentication device, the verification module 520 proves possession of the cryptographic authentication device by matching the sequence input verbally by the user to an expected value for the authentication sequence. As used herein, the “expected value” refers to the value expected or known by the authentication system (e.g., the verification module 520 or, more particularly, the cryptographic sequence verification engine 540) as being the sequence generated by the user's cryptographic authentication device at the time of login. As will be appreciated, the expected value of the authentication sequence is known by the authentication system via knowledge of a secret key that is unique to the user's cryptographic authentication device. The secret key can be used to derive the expected value given the time of submission of the user's login request. By verbally inputting a sequence that matches the expected value, the user proves with high likelihood that they possess the corresponding cryptographic authentication device.

The verification module 520 may leverage certain components to enhance recognition of the user's verbalized input of the authentication sequence. For example, the audio recording or voice data of the user's verbalized input may be fed to the speech recognition engine 525. The speech recognition engine 525 may use any conventional speech recognition technology by which spoken words are recognized and/or translated into text. Once the speech recognition engine 525 has recognized the user verbalized value for the authentication sequence, it may be provided to the cryptographic sequence verification engine 540 for comparison against the expected value for the current authentication sequence.

In accordance with certain embodiments, the video recording or face data of the user speaking the authentication sequence may be provided as an additional input to the speech recognition engine 525 and leveraged thereby to improve speech recognition. In such cases, the speech recognition engine 525 would be configured to include bimodal speech recognition. As will be appreciated, bimodal speech recognition refers to speech recognition that combines information from both audio and visual recordings of a person speaking to enhance recognition of what the person is saying. This type of functionality, for example, may prove particularly advantageous in poor audio conditions, where noise or a bad connection results in acoustically confusing words. Given the visual data of the user speaking the authentication sequence, a system that incorporates bimodal speech recognition can analyze lip and other facial movement alongside the sound recording to eliminate acoustic ambiguities. In short, with bimodal speech recognition, the available visual information may enable a sort of “lip reading” that can be used to improve upon recognition achievable from use of the sound recording alone. Further, as also described herein, such lip reading enables authentication where audible verbalization would be inappropriate. It will be appreciated that, in providing this, the present invention further utilizes the already available video recording of the user speaking the authentication sequence. This utilization achieves improved overall functionality, while substantially avoiding an attendant increase in complexity or data requirements due to the reuse of the available video recording.

Moving to the next operation, if it is determined that the user is verified in operation 625, the method 600 may continue to operation 630 where the user is granted access. If, however, it is determined that the user is not verified in operation 625, the method 600 may continue to 635 where the user is denied access.

Another possible result for operation 625, as illustrated, is a request for additional input from the user. For example, if the verification returns a confidence level that falls within a predetermined range or window—i.e., an insufficient level of confidence to grant immediate access but sufficient to indicate a likelihood of attaining verification with additional input—the method 600 may proceed to operation 640 where the user is prompted to provide that additional input. In addition, as described in more detail above, certain conditions pertaining to the user's login attempt that can cast doubt on what would otherwise be a successful user verification may warrant similar treatment. Thus, the “further input required” result may be triggered if the login attempt is being made from a new device, unexpected location, after a long period of no login attempts, or any of the other reasons provided above. As another alternative, further input can also be requested randomly.

Thus, according to exemplary embodiments, in operation 640, the user is prompted to provide additional input. Such additional input may include different types of requests aimed at providing to the authentication system more examples of user speech and/or facial or head movements. These inputs then may be used as additional voice and facial biometrics inputs and, thereby, allow the system to another chance to verify the identity of the user. The type of additional inputs may be randomly generated so to frustrate spoofing attempts. As an example, the user may be prompted to repeat a sequence of words chosen at random from a sufficiently large collection of words. As another example, the user may be asked to perform specific movements that involve facial or head movements, such as “close left eye”, “open mouth”, “smile”, “frown”, “turn to the right”, “tilt head”, etc. As another example, the specific movements may further involve the user's hand, such as “cover mouth with hand”, “touch nose with index finger”, “hold up thumb and index finger”, “show three fingers”, etc. As will be appreciated, the performance of such movements provides another “liveness verification” that prevent replay attacks. With the additional input provided, the method 600 may then continue with control being passed to operation 645.

In operation 645, the user is again verified. This verification may be performed in any of the ways described above in relation to operation 625. In this case, however, the verification may use information obtained via the additional inputs supplied by the user in operation 640. The verification may include either adjusting the previously calculated confidence level or making a new calculation. If it is determined that the user should be verified, the method 600 may continue to operation 630 where the user is granted access. On the other hand, if it is determined that the user should not be verified, the method 600 may continue to operation 635 where the user is denied access.

In accordance the present invention, verification of a user or individual will now be described in accordance with the data received at and actions taken by an authentication system remotely located in relation to a user device. Though other types of embodiments are also possible, the following examples emphasize the data received by the authentication system from the user device of the individual, the analyses performed by the authentication system on that data, and/or the responses made and/or actions taken by the authentication system based on the results of that analysis. The following embodiment may draw upon any of the technical aspects described above, whether or not explicitly stated, as would be understood by one of ordinary skill in the art.

According to an exemplary embodiment, a computer-implemented method is proposed for verifying the identity of an individual in order to grant the individual access to a computer system. The method may include the initial step of receiving, in one or more communications via one or more communication portals, channels, or network, a personal identifier of the individual. For example, the personal identifier may include text of a name or alias associated with the individual, audio of a name associated with the individual, an image of the individual, or any other biometric identifier.

The method may further include the step of receiving biometric data (or simply “data”) related to the individual speaking an authentication sequence. As will be seen, the data may include visual face data (or simply “face data”), which is data related to the visual appearance of the individual's face and/or the movement thereof as the individual speaks the authentication sequence. The data may also include voice data, which is data related to the sound of the individual's voice as the individual speaks the authentication sequence. As used herein, the term “face data” may include raw video data of the individual's face from the video recording or processed video data in which facial characteristics of the individual have been extracted from raw video data. Likewise, the term “voice data” may include either raw audio data of the individual's voice from the audio recording or processed audio data in which voice characteristics have been extracted from the raw audio data.

In exemplary embodiments, the present method may include the step of performing an identity proof that includes biometrics. In general, the identity proof may include: identifying a first set of biometric characteristics from the biometric data; retrieving, from a database, a second set characteristics linked to the personal identifier of the individual; and comparing the first set of characteristics against the second set of characteristics to determine a degree of similarity (hereinafter “similarity score”) therebetween. In an exemplary embodiment, the identity proof may include one or more different types of biometrics. For example, the identity proof may include a first identity proof that includes facial biometrics and/or a second identity proof that include voice biometrics.

Specifically, the first identity proof of facial biometrics may include the steps of: identifying a first set of facial characteristics from the face data; retrieving, from a database, a second set of facial characteristics linked to the personal identifier of the individual; and comparing the first set of facial characteristics to the second set of facial characteristics to determine to a degree of similarity (hereinafter “similarity score”) therebetween. The first set of facial characteristics and the second set of facial characteristics each may include characteristics unique to the individual related to one or more facial movements when speaking. The second identity proof of voice biometrics may include the steps of identifying a first set of voice characteristics for the individual from the voice data; retrieving, from a database, a second set of voice characteristics linked to the personal identifier of the individual; and comparing the first set of voice characteristics to the second set of voice characteristics to determine a similarity score.

In exemplary embodiments, the method may include the step of determining a recognized value of the authentication sequence spoken by the individual. As used herein, the recognized value refers to the value recognized from the received voice data and/or face data from the individual speaking the authentication sequence. As an example, the recognized value may represent a derived text version of the authentication sequence based on sound information contained in or derived from an audio recording and/or visual information contained in or derived from a video recording. To do this, speech recognition technology may be used that draws upon auditory clues from the voice data, visual clues from the face data, or a combination of both types of information. Accordingly, in the exemplary embodiment, the recognized value may be based on the audio recording or the video recording of the individual speaking the authentication sequence or data derived therefrom. For example, the recognized value may be based on the sound clues or information derived from solely the voice data of the individual speaking the authentication sequence, for example, by applying automatic speech recognition or speech-to-text technology. As another example, the recognized value may be based the visual clues or information derived solely from the visual face data of the individual speaking the authentication sequence. In this case, recognition may be based on the way the data associated with how the individual's lips move when speaking the authentication sequence. As a third possibility, the step of determining the recognized value of the authentication sequence may include bimodal speech recognition, in which case, both the voice data and the face data (i.e., the movement of the individual's lips) may be used in concert to recognize the values spoken by the individual when verbally inputting the authentication sequence.

In exemplary embodiments, the method may include the step of performing a proof of possession of an authentication device. For example, the proof of possession may include: determining an expected value for the authentication sequence; and comparing the expected value for the authentication sequence to the recognized value of the authentication sequence to determine whether the recognized value of the authentication sequence matches the expected value. It is generally necessary that a perfect match between these two values be shown for possession of the authentication device to be adequately proved. As described, the authentication sequence may be cryptographically generated authentication sequence. That is, the authentication sequence may be a sequence of random digits generated by a cryptographic device. The step of determining the expected value of the authentication sequence may include determining the sequence that would have been generated and provided to the individual by the particular cryptographic device linked to the personal identifier. To do this, a corresponding “time of login” or “submission time” may be needed. According to another example, the step of determining the expected value of the authentication sequence may include: retrieving a secret key of a cryptographic device linked to the personal identifier of the individual; determining a submission time corresponding to the individual speaking the authentication sequence (i.e., when the individual actually spoke the authentication sequence and submitted it for logging in); and calculating the expected value based on the secret key and the submission time.

In exemplary embodiments, the method may include the step of determining a confidence score for verifying the identity of the individual. The confidence score may be based on the similarity scores associated with one or more biometric proof. The confidence score also may be based on whether the recognized value of the authentication sequence was found to match the expected value of the authentication sequence.

In exemplary embodiments, the method may include the step of performing an act related to the granting the individual access to the computer system. The act may be selectively chosen or based on a comparison of the confidence score and a predetermined threshold. For example, if the confidence score determined for the individual satisfies the predetermined threshold required for granting access to the computer system, then the act may be to grant the individual access to the computer system. However, if the confidence score determined for the individual fails to satisfy the predetermined threshold, then the act may be to deny the individual access to the computer system. As a third option, if the confidence score determined for the individual falls within a predetermined range—i.e., an insufficient level of confidence to grant immediate access but sufficient to indicate a likelihood of attaining verification with additional input-then the act may be to send a communication prompting the individual for an additional input. The prompt may be for additional voice data relating to the individual repeating a sequence of words randomly selected from a list of candidate words. Alternatively, the prompt may be for additional face data of the individual performing a movement that is randomly selected from a list of candidate movements. The candidate movements each may include: a head movement; a facial expression; or a hand movement made in combination with a head movement or a facial expression. For example, the candidate movements may include: a mouth forming an expression; an eye closing; a head rotation or tilt; or a hand being placed to cover a specified portion of the face.

The several embodiments discussed above in relation to FIGS. 5 and 6 enable several advantages over conventional authentication approaches. As will be seen, many of these relate to the manner in which the several verification engines function in complimentary ways that promote convenience and efficiency, while also enhancing security. Several of these advantages will now be discussed in more specificity, though it should be understood that the following examples do not represent an exhaustive list nor does the order in which they are presented indicate any sort of relative importance.

First, the present embodiments promote efficient user verification. For example, the identity and possession proofs may be configured to occur concurrently, as each is based on the same user input action of speaking the authentication sequence.

Second, the present embodiments can be enabled via common user devices. That is, the systems and methods proposed herein do not require any specialized hardware and, instead, can be implemented via the standard microphones and cameras common to many modem devices, such as cell phones, tablets, and laptop computers.

Third, the present embodiments provide superior security of over alternative systems that rely on facial recognition. Specifically, while state of the art facial recognition is generally accurate, it can still be spoofed with static images. To alleviate this weakness, more sophisticated facial recognition systems incorporate specialized hardware to take 3-dimensional images of the users face and head. In contrast, the present invention addresses the same weakness without requiring any such specialized hardware, instead ably functioning with the standard camera available on most user devices. Specifically, by providing a video of the identity claimant speaking the authentication sequence, present embodiments are able to visually observe facial and lip movement and include this type of information in the facial recognition process. Because the spoken authentication sequence is also used as input for the voice biometrics system, the present embodiments operate in a way that fuse facial movements and speech signals unique to the user. Additionally, the video showing the movement of the user's face as they verbalize the authentication sequence may enhance the performance of the facial recognition biometrics by providing multiple different views of the user's face. As will be appreciated, the matching of multiple views to stored examples can provide more confident facial biometrics verification.

Fourth, the present embodiments can leverage the video of the user and aspects of facial recognition to improve the recognition of the digits of the authentication sequence when input verbally by the user. As will be appreciated, this aspect may be particularly useful in situations where acoustics make it difficult to recognize the digits by the user's voice alone.

Fifth, the present embodiments enable authentication that is convenient to users. As already touched on, the reasons for this include the manner in which multiple proofs of identity and the proof of possession are derived from a single verbal input by the user. As a further example, using voice activation, a highly secure user verification-which includes both voice biometrics and facial biometrics identity proofs as well as proof of possession of a cryptographic authentication device—can be achieved via the user simply looking into the camera of their smart phone and stating, “Connect to VPN with token value 888704”. Given that the authentication is being instigated from a device associated with the user, an initial identity proof is implicit in the authentication request itself and then then bolstered via confirmation of the token value. This identity claim is then verified via voice biometrics.

Sixth, the present embodiments offer a solution to a common disadvantage associated with the use of voice biometrics verification. Specifically, speaking as an input can be awkward in certain situations, like a quiet area, or problematic in noisy environments. For such situations, the present embodiments can rely on the “lip reading” capabilities (discussed above in relation to the bimodal speech recognition) for determining the user spoken values of the authentication sequence. Such cases, of course, would lack the voice biometrics verification, but this could be compensated for with additional security challenges to maintain the required security level. For example, the user may be asked to repeat challenge words with sufficiently distinct lip movements.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

That which is claimed:

1. A computer-implemented method for verifying an identity of an individual for granting the individual access to a computer system, the method including the steps of:
receiving, in one or more communications via one or more communication channels, a personal identifier of the individual;
receiving, in the one or more communications via the one or more communication channels, data related to the individual speaking an authentication sequence;
performing an identity proof that includes biometrics, the identity proof comprising:
identifying a first set of characteristics from the data;
retrieving, from a database, a second set characteristics linked to the personal identifier of the individual; and
comparing the first set of characteristics against the second set of characteristics to determine a degree of similarity (hereinafter “similarity score”) therebetween;
performing a proof of possession of an authentication device that includes:
determining a recognized value of the authentication sequence spoken by the individual based on the data;
determining an expected value of the authentication sequence;
determining whether the recognized value of the authentication sequence matches the expected value of the authentication sequence;
calculating a confidence score for verifying the identity of the individual based on both:
the similarity score; and
whether the recognized value of the authentication sequence is found to match the expected value of the authentication sequence.

2. The method according to claim 1, wherein the identity proof comprises facial biometrics, and the data comprises face data related to a face of the individual speaking the authentication sequence;
wherein the identity proof comprises:
identifying a first set of facial characteristics for the individual from the facial data;
retrieving, from a database, a second set of facial characteristics linked to the personal identifier of the individual; and
comparing the first set of facial characteristics against the second set of facial characteristics to determine the similarity score.

3. The method according to claim 2, wherein the face data comprises data of lip movement of the individual when speaking the authentication sequence; and
wherein the determining the recognized value of the authentication sequence is based on deciphering the authentication sequence based on the lip movement data.

4. The method according to claim 1, wherein the data comprises: face data related to a face of the individual speaking the authentication sequence; and voice data related to a voice of the individual speaking an authentication sequence;
wherein the identity proof comprises: a first identity proof comprising facial biometrics; and a second identity proof comprising voice biometrics;
wherein the first identity proof comprises:
identifying a first set of facial characteristics for the individual from the face data;
retrieving, from a database, a second set of facial characteristics linked to the personal identifier of the individual;
comparing the first set of facial characteristics against the second set of facial characteristics to determine a facial characteristics similarity score;
wherein the second identity proof comprises:
identifying a first set of voice characteristics for the individual from the voice data;
retrieving, from a database, a second set of voice characteristics linked to the personal identifier of the individual;
comparing the first set of voice characteristics against the second set of voice characteristics to determine a voice characteristics similarity score;
wherein the similarity score is based on both the facial characteristics similarity score and the voice characteristics similarity score; and
wherein the proof of possession of the authentication device includes determining the recognized value of the authentication sequence spoken by the individual based on at least one of the face data and the audio voice data.

5. The method according to claim 4, wherein the proof of possession of the authentication device includes determining the recognized value of the authentication sequence spoken by the individual based on both the facial data and the voice data.

6. The method according to claim 5, wherein the first set of facial characteristics and the second set of facial characteristics each comprises characteristics unique to the individual related to one or more facial movements when speaking.

7. The method according to claim 5, wherein the face data comprises data of lip movement of the individual when speaking the authentication sequence;
wherein the step of determining the recognized value of the authentication sequence includes bimodal speech recognition based on a combination of inputs that include:
the data of lip movement of the individual when speaking the authentication sequence; and
the voice data of the individual speaking the authentication sequence.

8. The method according to claim 4, further comprising the step of performing an act related to the granting the individual access to the computer system, the act being selectively based on a value of the confidence score compared to a predetermined threshold; and
wherein the face data comprises at least one of:
raw video data of the face of the individual speaking the authentication sequence; and
processed video data comprising one or more facial characteristics of the first set of facial characteristics;
wherein the voice data comprises at least one of:
raw audio data related to the voice of the individual speaking the authentication sequence; and
processed audio data comprising one or more voice characteristics of the first set of voice characteristics.

9. The method according to claim 8, wherein the confidence score determined for the individual satisfies the predetermined threshold required for granting access to the computer system; and
wherein the act comprises granting the individual access to the computer system.

10. The method according to claim 8, wherein the confidence score determined for the individual fails to satisfy the predetermined threshold required for granting access to the computer system; and
wherein the act comprises denying the individual access to the computer system.

11. The method according to claim 4, wherein further comprising the step of performing an act related to the granting the individual access to the computer system, the act being selectively based on a value of the confidence score compared to one or more predetermined thresholds, the one or more predetermined thresholds defining a first predetermined range; and
wherein the confidence score determined for the individual falls within the first predetermined range and the act comprises sending a communication prompting the individual for an additional input.

12. The method according to claim 11, wherein the additional input comprises a request for additional voice data relating to the individual repeating a sequence of words randomly selected from a list of candidate words.

13. The method according to claim 11, wherein the additional input comprises a request for additional face data of the individual performing a movement that is randomly selected from a list of candidate movements;
wherein the candidate movements each comprises at least one of:
a head movement;
a facial expression; and
a hand movement made in combination with a head movement or a facial expression.

14. The method according to claim 4, wherein the personal identifier comprises at least one of:
text of a name or alias associated with the individual;
voice data of a name associated with the individual; and
an image of the individual.

15. The method according to claim 4, wherein the authentication sequence comprises a cryptographically generated authentication sequence; and
wherein the step of determining the expected value of the authentication sequence comprises calculating a value of the authentication sequence that would have been provided to the individual at a time of login by a cryptographic device that is associated with the personal identifier of the individual.

16. A system for verifying an identity of an individual for granting the individual access to a computer system, the system comprising:
a hardware processor; and
a machine-readable storage medium on which is stored instructions that cause the hardware processor to execute a process, wherein the process comprises:
receiving, in one or more communications via one or more communication channels, a personal identifier of the individual;
receiving, in the one or more communications via the one or more communication channels, data related to the individual speaking an authentication sequence;
performing an identity proof that includes biometrics, the identity proof comprising:
identifying a first set of characteristics from the data;
retrieving, from a database, a second set characteristics linked to the personal identifier of the individual; and
comparing the first set of characteristics against the second set of characteristics to determine a degree of similarity (hereinafter “similarity score”) therebetween;
performing a proof of possession of an authentication device that includes:
determining a recognized value of the authentication sequence spoken by the individual based on the data;
determining an expected value of the authentication sequence;
determining whether the recognized value of the authentication sequence matches the expected value of the authentication sequence;
calculating a confidence score for verifying the identity of the individual based on both:
the similarity score; and
whether the recognized value of the authentication sequence is found to match the expected value of the authentication sequence.

17. The system according to claim 16, wherein the data comprises: face data related to visual characteristics of a face of the individual speaking the authentication sequence; and voice data related to sound characteristics of a voice of the individual speaking an authentication sequence;
wherein the identity proof comprises: a first identity proof comprising facial biometrics; and a second identity proof comprising voice biometrics;
wherein the first identity proof comprises:
identifying a first set of facial characteristics for the individual from the face data;
retrieving, from a database, a second set of facial characteristics linked to the personal identifier of the individual;
comparing the first set of facial characteristics against the second set of facial characteristics to determine a facial characteristics similarity score;
wherein the second identity proof comprises:
identifying a first set of voice characteristics for the individual from the voice data;
retrieving, from a database, a second set of voice characteristics linked to the personal identifier of the individual;
comparing the first set of voice characteristics against the second set of voice characteristics to determine a voice characteristics similarity score;
wherein the similarity score is based on both the facial characteristics similarity score and the voice characteristics similarity score; and
wherein the proof of possession of the authentication device includes determining the recognized value of the authentication sequence spoken by the individual based on at least one of the face data and the audio voice data.

18. The system according to claim 17, wherein the proof of possession of the authentication device includes determining the recognized value of the authentication sequence spoken by the individual based on both the facial data and the voice data.

19. The system according to claim 18, wherein the face data comprises data of lip movement of the individual when speaking the authentication sequence;
wherein the step of determining the recognized value of the authentication sequence includes bimodal speech recognition based on a combination of inputs that include:
the data of lip movement of the individual when speaking the authentication sequence; and
the voice data of the individual speaking the authentication sequence.

20. The system according to claim 17, wherein the process further comprises the step of performing an act related to the granting the individual access to the computer system, the act being selectively based on a value of the confidence score compared to a predetermined threshold; and
wherein the act comprises at least one of: granting the individual access to the computer system;
and denying the individual access to the computer system.
